(19) United States
(12) Patent Application Publication
(10) Pub. No.: US 2013/0135342 A1
(43) Pub. Date: May 30, 2013

(54) APPARATUS AND METHOD OF PORTABLE TERMINAL OF CONTROLLING WINDOW GENERATED IN DIFFERENT PROCESS

(71) Applicant: Samsung Electronics Co. Ltd., Suwon-si (KR)

(72) Inventor: Hee-Ju KANG, Suwon-si (KR)

(73) Assignee: SAMSUNG ELECTRONICS CO. LTD., Suwon-si (KR)

(21) Appl. No.: 13/683,406

(22) Filed: Nov. 21, 2012

(30) Foreign Application Priority Data
Nov. 24, 2011 (KR) 10-2011-0123377

(51) Int. Cl. G06T 11/00

(52) U.S. Cl. CPC G06T 11/00
USPC 345/619

(57) ABSTRACT

An apparatus and method of a portable terminal of controlling a window generated in a different process are provided. The method includes displaying a 1st window through a 1st process, displaying a 2nd window through a 2nd process different from the 1st process, and, if a specific key of the 1st window is input, displaying a 3rd window through the 1st process together with the 2nd window.

### PRIORITY

This application claims the benefit under 35 U.S.C. §119(a) of a Korean patent application filed in the Korean Intellectual Property Office on Nov. 24, 2011 and assigned Serial No. 10-2011-0123377, the entire disclosure of which is hereby incorporated by reference.

### BACKGROUND OF THE INVENTION

1. Field of the Invention

The present invention relates to an apparatus and method of a portable terminal of controlling a window generated in a different process.

2. Description of the Related Art

With the sudden development of the Internet, several devices became able to open various applications. In addition, great development has been made for a multitasking function of, during broadcasting viewing, searching the Internet and simultaneously opening several applications.

However, in the related art, when a user opens another application after opening one application, the later opened application suffers an operation limitation. For example, if a first opened application is displayed in a full window, a later opened application may be displayed in a partial window and, when a partial window of the full window is displayed, the partial window of the later opened application may close or be disabled.

As a result, there is no function of simultaneously displaying a partial window of a first opened application and a partial window of a later opened application. Accordingly, there is a need for the development of an apparatus and method for simultaneously controlling windows that operate in different processes.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above problems and/or disadvantages and to provide at least the advantages below. Accordingly, an aspect of the present invention is to provide an apparatus and method for simultaneously controlling windows that operate in different processes.

Another aspect of the present invention is to provide an apparatus and method for, in a 1st window and a 2nd window operating in different processes, setting the 2nd window as a child window of the 1st window and simultaneously operating the 1st window and the 2nd window.

The above aspects are achieved by providing an apparatus and method of a portable terminal of controlling a window generated in a different process.

According to an aspect of the present invention, an operation method of a portable terminal of controlling a window generated in a different process is provided. The method includes displaying a 1st window through a 1st process, displaying a 2nd window through a 2nd process different from the 1st process, and, if a specific key of the 1st window is input, displaying a 3rd window through the 1st process together with the 2nd window.

According to another aspect of the present invention, an apparatus of a portable terminal of controlling a window generated in a different process is provided. The apparatus includes a controller and an input unit. The controller controls to display a 1st window through a 1st process, controls to display a 2nd window through a 2nd process different from the 1st process, and controls to display a 3rd window through the 1st process together with the 2nd window. The input unit receives an input of a specific key of the 1st window.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the certain exemplary embodiments of the present invention will be more apparent from the following description taken in conjunction with the accompanying drawings, in which:

FIG. 1 is a block diagram illustrating the whole construction of a system according to an exemplary embodiment of the present invention;

FIG. 2 is a diagram illustrating a portable terminal of a window generated in a different process according to an exemplary embodiment of the present invention;

FIG. 3 is a diagram illustrating a construction of a portable terminal according to an operation sequence according to an exemplary embodiment of the present invention;

FIG. 4 is a flowchart illustrating an operation method of generating a 1st window to a 3rd window according to an exemplary embodiment of the present invention;

FIG. 5 is a flowchart illustrating an operation method of a portable terminal of controlling a window generated in a different process according to the present invention; and

FIG. 6 is a block diagram illustrating a construction of a portable terminal of controlling a window generated in a different process according to the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention may be implemented in an electronic device including a portable terminal such as, for example, a smart phone and a mobile telecommunication terminal. Hereunder, a portable terminal is used as an example for the electronic device.

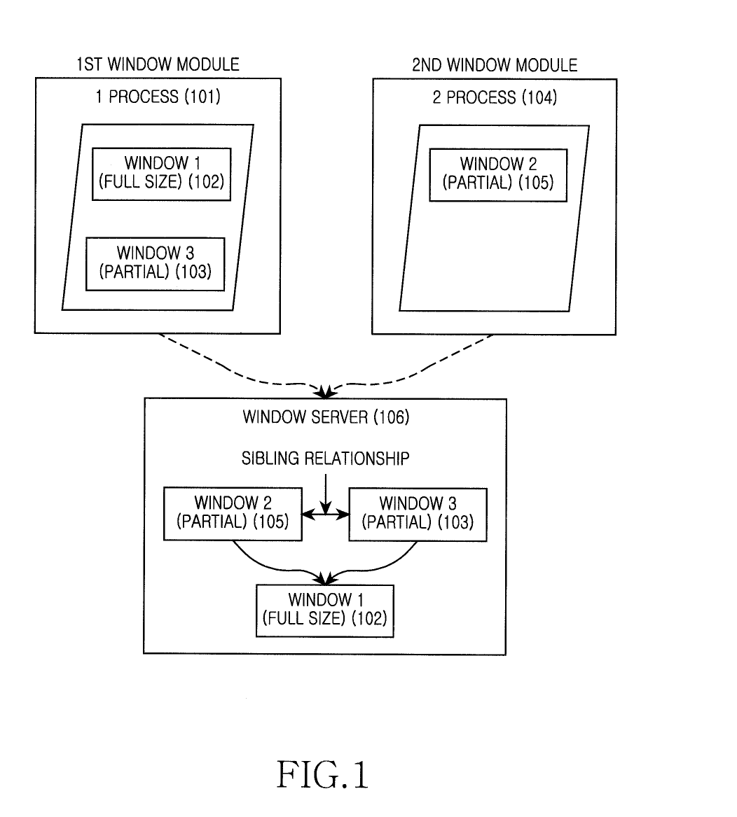

FIG. 1 is a block diagram illustrating the whole construction of a system according to an exemplary embodiment of the present invention.

Referring to FIG. 1, the system may include a 1st window module 101 using a 1st process, a 2nd window module 104 using a 2nd process, and a window server 106.

The 1st window module 101 is a module for generating a 1st window 102 and a 3rd window 103 using the 1st process. The 1st window module 101 is a module for generating the specific 1st window 102 and 3rd window 103 in a display unit of a portable terminal using the specific 1st process. The 1st window module 101 is controlled by the specific 1st process, and generates specific full window and partial window in the display unit of the portable terminal. The 1st window module 101 may be an application generating the specific 1st window 102 and 3rd window 103. For example, if a user installs and opens a specific application in the portable terminal, the specific 1st window 102 and 3rd window 103 are generated. The 1st window module 101 becomes an application. The concepts of the process, the full window, and the partial window are described below.

The process denotes a task, which is registered to a kernel and is under the management of the kernel. The process is defined as a program in execution or a task in execution. Accordingly, the process may be defined as various processes set by a user.

The full window is a window fully displayed in the display unit of the portable terminal, among windows displayed in the display unit of the portable terminal. For example, the full window may be a window fully displayed in the display unit of the portable terminal when the user opens a specific application installed in the portable terminal.

The partial window is a window partially displayed in the display unit of the portable terminal, among the windows displayed in the display unit of the portable terminal For example, the partial window may be a window partially displayed in the portable terminal when the user opens a different specific application after opening a specific application installed in the portable terminal

The 2nd window module 104 is a module for generating a 2nd window 105 using a 2nd process. The 2nd window module 104 is a module for generating the specific 2nd window 105 in the display unit of the portable terminal using the specific 2nd process. The 2nd window module 104 is controlled by the specific 2nd process, and generates a specific partial window in the display unit of the portable terminal Like the 1st window module 101, the 2nd window module 104 may be an application generating the specific 2nd window 105. For example, the specific 2nd window 105 may be generated when a user installs and opens a specific application in the portable terminal.

FIG. 1 illustrates only the 1st window module 101 and the 2nd window module 104, but a plurality of window modules may be installed according to user's need. A 4th window module using a specific 3rd process, a 5th window module using a 4th process and the like may be installed according to user's need.

The window server 106 integrates and manages windows generated in the 1st window module 101 and the 2nd window module 104. The window server 106 is connected with window modules controlled by different processes and integrates and manages at least one or more window modules, and may manage dependency among the respective windows. For example, the 1st window 102 and 3rd window 103 generated by the 1st window module 101 using the 1st process, and the 2nd window 105 generated by the 2nd window module 104 using the 2nd process are separate windows controlled by different processes, and do not have dependency between each other. However, if the window server 106 mutually manages dependency between the 1st window module 101 and the 2nd window module 104, any one window may be set as a parent of the other window. The 1st window 102 and the 2nd window 105 are separate windows using different processes, but, if the window server 106 manages the 2nd window 105 dependent on the 1st window 102, the 1st window 102 becomes a parent window of the 2nd window 105. Accordingly, when the 2nd window module 104 generates the 2nd window 105, the 2nd window 105 is set in sibling relationship with the 3rd window 103 that is in child relationship with the 1st window 102, and the 2nd window 105 is affected by the 1st window 102.

The 1st window module 101 illustrated in FIG. 1 is described below. After the full window, which is the specific 1st window 102, is generated using the specific 1st process, the specific 3rd window 103, which is the partial window of the 1st window 102, is generated. The 1st window 102 and the 3rd window 103 are controlled by the same process, i.e., the specific 1st process, and the 1st window 102 is a parent window of the 3rd window 103. When the 3rd window 103 is generated dependent on the 1st window 102, the 3rd window 103 is generated so that the 1st window 102 may operate.

The 2nd window module 104 illustrated in FIG. 1 is described below. The specific 2nd window 105 is generated using the specific 2nd process. The 1st window 102 and 3rd window 103 and the 2nd window 105 are different windows controlled by separate processes. However, as described above, the 2nd window 105 is set as a child window of the 1st window 102 and thus, the 3rd window 103 and the 2nd window 105 are in sibling relationship. Accordingly, when the 2nd window 105 is generated, the 2nd window 105 is generated under the influence of the 1st window 102 and the 3rd window 103. Therefore, when the 2nd window 105 is generated later, operations of the first generated 1st window 102 and 3rd window 103 are possible.

The window server 106 sets the 1st window module 101 using the different process as a parent of the 2nd window module 104 using the different process. The 1st window module 101 is set as a parent of the 2nd window module 104. The 2nd window module 104 is set as a child of the 1st window module 101. Accordingly, the 2nd window 105 generated by the 2nd window module 104 is in sibling relationship with the 3rd window 103 generated by the 1st window module 101. Therefore, the 2nd window 105 generated by the 2nd window module 104 is operated under the influence of the first generated 3rd window 103.

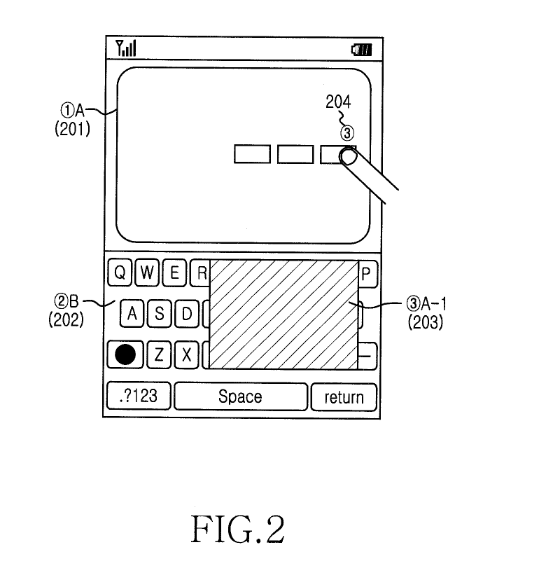

FIG. 2 is a diagram illustrating a portable terminal of controlling a window generated in a different process according to an exemplary embodiment of the present invention.

Referring to FIG. 2, a 1st window 201 shown in a full window in a display unit of the portable terminal and a 3rd window 204 shown in a partial window in the display unit of the portable terminal are windows controlled by a specific 1st process. A 2nd window 202 shown in another partial window in the display unit of the portable terminal is a window controlled by a specific 2nd process.

A case where a user installs and opens a specific application in a portable terminal is described as an example. First, when the user installs and opens the specific application, a full window controlled by a specific 1st process is generated in the display unit of the portable terminal For example, when the user plays a specific game, a main screen of the game is generated in a full window in the display unit of the portable terminal. A partial window that is an input tool controlled by the specific 2nd process is generated. The input tool is generated below the main screen so that the user may input a password before starting the game. The user inputs his/her own password through the input tool generated as the partial window in the portable terminal, and presses a start button 203 that is a specific button shown over the input tool.

If the user inputs his/her own password and presses the start button 203, the 3rd window 204 is generated in another partial window that is a pop-up menu related to the game. This 3rd window 204 is controlled by the 1st process. This is because the start button 203 is a button displayed in the screen of the 1st window 201 using the 1st process. The 1st window 201 that is the full window and the 3rd window 204 that is the partial window generated by user's selecting the start button 203 displayed in the 1st window 201 are generated by the same specific 1st process. Unlike this, the 2nd window 202 that is the first generated input tool is generated by the specific 2nd process. The 2nd window 202 is generated apart from the 1st window 201 and the 3rd window 204, but may affect operations of the 1st window 201 and the 3rd window 204.

The related art closes the 2nd window 202 that is the first generated input tool, when generating the 3rd window 204 that is the pop-up menu. The 2nd window 202 and the 3rd window 204 are controlled by different processes, and there is no influence between operations of the 2nd window 202 and the 3rd window 204. For example, when the user inputs a password through the input tool and, to start the game, presses the start button but the input tool window closes, so there is an inconvenience in playing the game. According to the related art, the closed input tool must be displayed again in order to play the game through the input tool.

As shown in FIG. 1, exemplary embodiments of the present invention set the 2nd window 202 and 3rd window 204 using different processes to be in mutual sibling relationship and, when the 3rd window 204 is generated, set the 3rd window 204 to affect an operation of the first generated 2nd window 202. In the aforementioned example, in a case where the start button 203 is pressed, a window server sets the pop-up menu that is the 3rd window 204 to be in child relationship with the full window that is the 1st window 201. Even when the user presses the start button 203, because the 2nd window 202 and the 3rd window 204 are set to be in sibling relationship, the input tool is not closed. So, the user may keep playing the game. As a result, the user may just play the game without needing to display the input tool again, so there is an advantage that a user's convenience is improved.

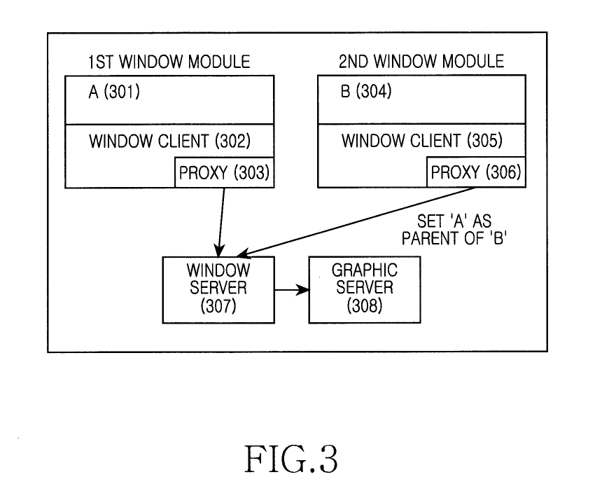

FIG. 3 is a diagram illustrating a construction of a portable terminal according to an operation sequence according to an exemplary embodiment of the present invention.

Referring to FIG. 3, the portable terminal may include a 1st window module 301, a 2nd window module 304, a window server 307, and a graphic server 308.

The 1st window module 301 may include a window client 302 and a proxy 303. The window client 302 manages a process of the 1st window module 301 that is a corresponding window module. The proxy 303 requests the window server 307 to display a 1st window. The window client 302 of the 1st window module 301 wholly manages the process within the 1st window. In a case where the 1st window module 301 intends to generate the 1st window, the proxy 303 receives a command of 1st window generation from the window client 302, and requests the window server 307 to display the 1st window.

The 2nd window module 304 may include a window client 305 and a proxy 306. The window client 305 manages a process of the 2nd window module 304 that is a corresponding window module, and sets a displayed 1st window as a parent. The proxy 306 requests the window server 307 to display a 2nd window. The window client 305 of the 2nd window module 304 wholly manages the process within the 2nd window. When the 2nd window module 304 intends to generate the 2nd window, the proxy 306 receives a command of 2nd window generation from the window client 305, and requests the window server 307 to display the 2nd window. The proxy 306 receives a command of setting the 1st window as a parent from the window client 305, and transmits the command to the window server 307.

The window server 307 is requested to display the 1st window and the 2nd window from the proxy 303 of the 1st window module 301 and the proxy 306 of the 2nd window module 304, and receives a command of setting the generated 1st window as a parent from the proxy 306 of the 2nd window module 304, and integrates and manages the 2nd window as a child of the 1st window.

The graphic server 308 receives, from the window server 307, a request for generation of the 1st window and the 2nd window that the window server 306 has received from the proxy 303 of the 1st window module 301 and the proxy 306 of the 2nd window module 304, and displays the 1st window and the 2nd window in a display unit of the portable terminal. Although FIG. 3 illustrates and describes the 1st window module 301 and the 2nd window module 304, as described above, exemplary embodiments of the present invention may install a plurality of window modules and generate a plurality of windows.

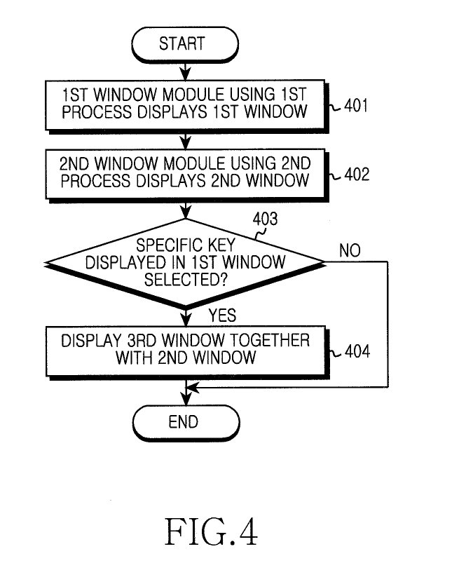

FIG. 4 is a flowchart illustrating an operation method of generating a 1st window to a 3rd window according to an exemplary embodiment of the present invention.

Referring to FIG. 4, a 1st window module using a 1st process displays a 1st window in step 401. The 1st window module installed by a user is a module controlled by the specific 1st process and, if a user enables the 1st window module, the 1st window is generated in a display unit of a portable terminal The 1st window may be a first generated window and may be generated in a full window in the display unit of the portable terminal. As described above, the full window refers to a window fully displayed in the display unit of the portable terminal.

After the 1st window is generated in the full window by the 1st window module in the portable terminal, a 2nd window module using a 2nd process displays a 2nd window in step 402. The 2nd window module installed by the user is a module controlled by the specific 2nd process and, if the user enables the 2nd window module, the 2nd window is generated in the display unit of the portable terminal. The 2nd window may be a window displayed after the 1st window is generated as the full window and therefore, the 2nd window is generated in a partial window in the display unit of the portable terminal. As described above, the partial window refers to a window partially displayed in the display unit of the portable terminal.

The portable terminal determines if a specific key displayed in the 1st window is selected in step 403. The full window, the 1st window, is first generated by the 1st window module in the display unit of the portable terminal and then, the partial window, the 2nd window, is generated by the 2nd window module in the display unit of the portable terminal. The portable terminal determines if a specific key displayed in the 1st window is selected by the user. For example, if the user opens a specific application, a main screen becomes the 1st window first displayed on the display unit of the portable terminal. After the main screen is displayed, an input tool that is the 2nd window is displayed by the 2nd window module in order for the portable terminal to receive an input of a password from the user. The portable terminal receiving the input of the password from the user through the input tool determines if it receives an input of a start button displayed over the main screen.

If it is determined that the specific key is selected by the user, the portable terminal displays a 3rd window together with the 2nd window at step 404. Displaying the 3rd window together with the 2nd window does not mean that the first generated 2nd window closes or cannot operate due to generation of the later generated 3rd window. The portable terminal sets the 2nd window and 3rd window controlled by different processes to be in sibling relationship so that, although the 3rd window is generated after the 2nd window is generated, the portable terminal may operate the 2nd window. For example, even after the input tool that is the 2nd window is generated, when the 3rd window will be generated, the portable terminal sets the 2nd window and the 3rd window to be in sibling relationship so that the input tool, the 2nd window, is not closed and the pop-up menu, the 3rd window, is generated. If the specific key displayed in the 1st window is not selected by the user, the 2nd and/or 3rd window may be closed.

The method described above in relation with FIG. 4 under of the present invention may be provided as one or more instructions in one or more software modules, or computer programs stored in an electronic device including a portable terminal.

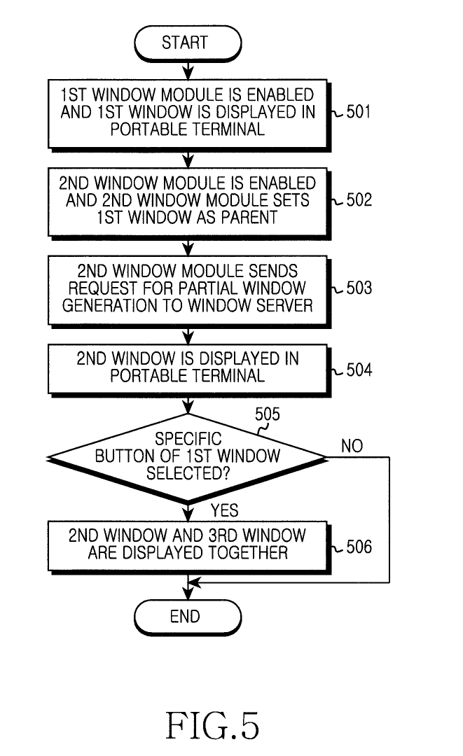

FIG. 5 is a flowchart illustrating an operation method of a portable terminal of controlling a window generated in a different process according to the present invention.

Referring to FIG. 5, a case of installing and opening a specific application in a portable terminal of a user is described as an example. As illustrated in FIG. 5, a 1st window module is enabled and a 1st window is displayed in the portable terminal in step 501. When opening a specific application installed in the portable terminal, a main screen is displayed on a display unit of the portable terminal The 1st window is fully displayed in a full window on the display unit of the portable terminal.

After the 1st window is displayed in the portable terminal, a 2nd window module is enabled and the 2nd window module sets the 1st window as a parent in step 502. A window client of the 2nd window module sets the 1st window as a parent of a 2nd window. The portable terminal sets the 2nd window as a child of the 1st window, and forwards a command in which the 2nd window has been set as the child of the 1st window, to a proxy of the 2nd window module. The proxy of the 2nd window module receives the aforementioned command from the window client of the 2nd window module, and forwards the command to a window server. The window server receives the aforementioned command from the proxy, and integrates and manages the 1st window and the 2nd window.

The 2nd window module sends a request for partial window generation to the window server at step 503. The 2nd window module sends a request for input key generation to the window server to display an input key in the portable terminal so that the user may open an application. The first generated 1st window is generated as a full window in the main screen, and the portable terminal requests the window server to generate a partial window that is an input key so as to receive, for example, an input of a user's password.

The window server receiving the request for partial window generation from the 2nd window module displays the 2nd window in the portable terminal in step 504. The portable terminal displays the input key in the partial window in the display unit of the portable terminal to receive an input of a password and the like from the user. As described above, the window server may integrally manage the respective window modules, and manage even dependent relationship. The window server receives, from the 2nd window module, a request for the 2nd window module to set the 1st window as the parent, and the window server sets the 2nd window as a child window of the 1st window. Accordingly, the 2nd window displayed on the display unit of the portable terminal is displayed as the child window of the 1st window on the display unit of the portable terminal.

The portable terminal determines if a specific button of the 1st window is selected by the user in step 505. The portable terminal determines if a start button of the 1st window displayed on the display unit of the portable terminal is selected by the user. This is because the portable terminal should receive a selection of the start button from the user together with the password in order to start a game in the portable terminal.

If the portable terminal determines that the specific button displayed in the 1st window is selected from the user, the 2nd window and the 3rd window are displayed together in step 506. The 3rd window is set to be in sibling relationship with the 2nd window and therefore, even in a case where the 3rd window is displayed on the display unit of the portable terminal, the 2nd window may be operated. Even when the pop-up menu, the 3rd window, is displayed by user's selection on the display unit of the portable terminal, the input key, which is the 2nd window, is not closed and may be operated. Accordingly, after the user presses the start button to start the game, the user may select the input key even after the pop-up menu is displayed on the display unit of the portable terminal, so a user's convenience is improved. If the portable terminal determines that the specific button of the 1st window is not selected by the user, the pop-up menu that is the 3rd window is not displayed, and may be closed. The user cannot just start the game.

The method described above in relation with FIG. 5 under of the present invention may be provided as one or more instructions in one or more software modules, or computer programs stored in an electronic device including a portable terminal.

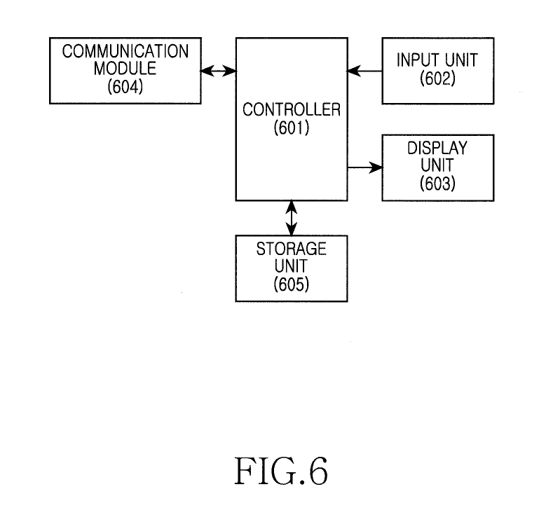

FIG. 6 is a block diagram illustrating a construction of a portable terminal of controlling a window generated in a different process according to the present invention.

Referring to FIG. 6, the portable terminal may include a controller 601, an input unit 602, a display unit 603, a communication module 604, and a storage unit 605.

A touch sensitive display, called as a touch screen, may be used as the display unit 603. In this situation, a touch input may be performed via the touch sensitive display.

The controller 601 controls the general operation of the portable terminal. The controller 601 may include a 1st window module, a 2nd window module, a window server, and a graphic server. For example, the 1st window module may include a window client and a proxy. The window client manages a process of the 1st window module that is a corresponding window module. The proxy requests the window server to display the 1st window. The window client of the 1st window module manages a process within the 1st window. When the 1st window module intends to generate the 1st window, the proxy receives a command of 1st window generation from the window client, and requests the window server to display the 1st window.

The 2nd window module may include a window client and a proxy. The window client manages a process of the 2nd window module that is a corresponding window module, and sets the displayed 1st window as a parent. The proxy requests the window server to display the 2nd window. The window client of the 2nd window module manages a process within the 2nd window. When the 2nd window module intends to generate the 2nd window, the proxy receives a command of 2nd window generation from the window client, and requests the window server to display the 2nd window. The proxy receives a command of setting the 1st window from the window client and transmits the command to the window server.

The window server is requested to display the 1st window and the 2nd window from the proxy of the 1st window module and the proxy of the 2nd window module, and receives a command of setting the generated 1st window as the parent from the proxy of the 2nd window module and integrates and manages the 2nd window as the child of the 1st window.

The graphic server receives, from the window server, a request for 1st window and 2nd window generation that the window server has received from the proxy of the 1st window and the proxy of the 2nd window, and displays the 1st window and the 2nd window on the display unit of the portable terminal.

The input unit 602 provides input data generated by user's selection, to the controller 601.

The display unit 603 displays status information of the portable terminal, menu screen and story information according to the control of the controller 601. For example, the display unit 603 receives, from the window server, a request for displaying the 1st and 2nd windows generated by the 1st and 2nd window modules on the display unit 603 of the portable terminal, and displays the 1st window and the 2nd window on the display unit 603 of the portable terminal by the graphic server.

The communication module 604 processes a signal transmitted/received through an antenna for voice and data communication.

The storage unit 605 may include a program storage unit and a data storage unit. The program storage unit stores a program for controlling an operation of the portable terminal. The data storage unit stores data generated in execution of a program.

In the aforementioned construction, the controller 601 may perform the general function of the terminal. As described herein, these are separately constructed and shown in order to distinguish and describe respective functions. When a product is actually realized, construction may be such that the controller 601 may process all of the functions of the terminal or may process only some of the functions.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. An operation method of a portable terminal of controlling a window generated in a different process, the method comprising:
displaying a 1st window through a 1st process;
displaying a 2nd window through a 2nd process different from the 1st process; and
if a specific key of the 1st window is input, displaying a 3rd window through the 1st process together with the 2nd window.

2. The method of claim 1, wherein the 1st window comprises a full window, and the 2nd window and the 3rd window comprise a partial window.

3. The method of claim 1, wherein the displaying of the 1st window further comprises:
in a 1st window module using the 1st process, requesting a window server to display the 1st window; and
in a graphic server, receiving the request from the window server, and displaying the 1st window.

4. The method of claim 1, wherein the displaying of the 2nd window further comprises:
in a 2nd window module using the 2nd process, setting the displayed 1st window as a parent;
in the 2nd window module, requesting a window server to display the 2nd window; and
in a graphic server, receiving the request from the window server, and displaying the 2nd window.

5. The method of claim 1, wherein the specific key of the 1st window comprises a specific key for generating the 3rd window if the specific key is input.

6. The method of claim 1, wherein the displaying of the 3rd window through the 1st process together with the 2nd window further comprises:
in a 1st window module using the 1st process, requesting a window server to display the 3rd window that is a child of the 1st window; and
in a graphic server, receiving the request from the window server, and displaying the 3rd window over the 2nd window.

7. The method of claim 1, wherein the displaying of the 3rd window through the 1st process together with the 2nd window comprises overlapping and displaying the 2nd window and the 3rd window.

8. The method of claim 1, wherein the 3rd window is set as a child of the 1st window, and the 2nd window is set as a sibling of the 3rd window.

9. An apparatus of a portable terminal of controlling a window generated in a different process, the apparatus comprising:
a controller for controlling to display a 1st window through a 1st process, for controlling to display a 2nd window through a 2nd process different from the 1st process, and for controlling to display a 3rd window through the 1st process together with the 2nd window; and
an input unit for receiving an input of a specific key of the 1st window.

10. The apparatus of claim 9, wherein the 1st window comprises a full window, and the 2nd window and another window comprise a partial window.

11. The apparatus of claim 9, wherein the controller comprises:
a 1st window module using the 1st process;
a window server for receiving a request to display the 1st window from the 1st window module; and
a graphic server for receiving the request from the window server, and displaying the 1st window,
the 1st window module comprising:
a window client for managing a process of the 1st window module; and
a proxy for requesting the window server to display the 1st window.

12. The apparatus of claim 9, wherein the controller comprises:
a 2nd window module using the 2nd process;
a window server for receiving a request to display the 2nd window from the 2nd window module; and
a graphic server for receiving the request from the window server, and displaying the 2nd window,
the 2nd window module comprising:
a window client for managing a process of the 2nd window module, and for setting the displayed 1st window as a parent; and
a proxy for requesting the window server to display the 2nd window.

13. The apparatus of claim 9, wherein the specific key of the 1st window comprises a specific key for generating the 3rd window if the specific key is input.

14. The apparatus of claim 9, wherein the controller comprises:
a 1st window module using the 1st process;
a window server for receiving a request to display the 1st window from the 1st window module; and
a graphic server for receiving the request from the window server, and displaying the 1st window,
the 1st window module comprising a proxy for requesting the window server to display a 3rd window that is a child of the 1st window.

15. The apparatus of claim 9, further comprising a graphic server for overlapping and displaying the 2nd window and the 3rd window.

16. The apparatus of claim 9, wherein the controller sets the 3rd window as a child of the 1st window, and sets the 2nd window as a sibling of the 3rd window.

17. The apparatus of claim 9, further comprising a display unit for displaying the 1st window, the 2nd window, and the 3rd window.
